(19) United States
(12) Patent Application Publication
(10) Pub. No.: US 2026/0251237 A1
(43) Pub. Date: Aug. 27, 2026

(54) DEVICE FOR VIBRATION-DAMPING GUIDANCE OF PIPING

(71) Applicant: SAFRAN AEROSYSTEMS, Plaisir (FR)

(72) Inventors: Jean-Francois Roche, Moissy-Cramayel (FR); Jérémy Woiret, Moissy-Cramayel (FR)

(73) Assignee: SAFRAN AEROSYSTEMS, Plaisir (FR)

(21) Appl. No.: 18/876,968

(22) PCT Filed: Jun. 15, 2023
(86) PCT No.: PCT/FR2023/050871

§ 371 Date: Dec. 19, 2024

(30) Foreign Application Priority Data
Jun. 22, 2022 (FR) 2206159

(51) Int. Cl. F16L 3/01; F16C 17/02

(52) U.S. Cl. CPC F16L 3/01; F16C 17/022

(57) ABSTRACT

This device for guiding a piping comprises a bearing made of a material with a low coefficient of friction and configured to encircle a pipe of the piping, an insert radially encapsulating the bearing, at least one elastic means radially surrounding the insert and a shell positioned around the bearing, the elastic means and the insert.

### TECHNICAL FIELD

The present invention relates to the field of spring boxes used in industrial piping.

In particular, the present invention relates to piping guide devices allowing absorbing the vibrations that could wear the piping, and in particular aircraft, ship or submarine piping.

In general, the invention applies to all devices for damping guidance of piping.

### PRIOR ART

The guidance and support of a piping are generally achieved by a pivot connection in which a pipe of the piping passes longitudinally according to a longitudinal degree of freedom in a friction ring connected to a support.

In general, the pipe and the ring are subjected to frictions due to the longitudinal movement of the pipe in the ring. In general, the friction conditions are reduced to metal-metal, metal-polytetrafluoroethylene-made fabric, or metal-silicone material pairs.

In operation, in other words in the condition of use taking account of the assembly tolerances, the thermal expansion effects and the vibratory effects, a wear of the surfaces in contact with the pipe and of the ring is generally observed resulting in losses of load-bearing and damping performances.

In general, a coil spring could be mounted proximate to the pivot connection in order to enable damping of the piping when subjected to vibrations whose axis is parallel to the longitudinal axis of the spring.

However, the wear of the ring remains significant, in particular during vibrations under resonance.

### DISCLOSURE OF THE INVENTION

Hence, the present invention aims to overcome the aforementioned drawbacks and to provide a pipe guide device that is both effective in vibration damping and simple to manufacture.

An object of the present invention is a device for guiding a piping, the device comprising a bearing made of a material with a low coefficient of friction and configured to encircle a pipe of the piping, an insert radially encapsulating the bearing, at least one elastic means radially surrounding the insert, and a shell positioned around the bearing, the elastic means and the insert.

By “coefficient of friction”, it should be understood the ratio between the tangential force and the normal force applied on the surfaces of the bearing. In particular, by “low coefficient of friction”, it should be understood a coefficient of friction lower than the coefficients of friction of the materials commonly used for making piping. For example, the coefficient of friction of the material in which the bearing is made is lower than 0.25, preferably lower than 0.15.

Thus, the bearing allows for less wear and, in particular, allows reducing the oligo-cyclic fatigue stresses (“low-cycle fatigue” in Anglo-Saxon terminology) as well as the vibratory stresses (“high-cycle fatigue” in Anglo-Saxon terminology), also attenuated by the presence of the elastic means which, in particular, allows guaranteeing a second radial degree of freedom in addition to the longitudinal degree of freedom.

In one embodiment, the elastic means comprises a corrugated leaf spring.

Advantageously, each of the bearing, the insert and the shell comprises at least two elements so that disassembling the guide device could be carried out without disassembling the piping.

In one embodiment, the insert is made of a metal material and comprises grooves configured to accommodate metal staples configured to connect the two elements of the insert.

The metal staples allowing holding the two elements of the insert fixed with respect to one another, holding being achieved, for example, by welding the metal staples to the two elements of the insert.

In a particular embodiment, the shell is made of a metal material and comprises a tubular central surface configured to be at least partially in contact with the elastic means, and two annular shoulders extending the longitudinal ends of the tubular central surface towards the longitudinal axis of the guide device and of the piping, the two annular shoulders being configured to longitudinally hold the bearing, the elastic means and the insert.

Advantageously, the device comprises a first support and a second support each comprising an annular portion and a radial planar portion configured to be positioned radially on the shell, the annular portions of the first and second supports comprising means for reversible fastening to the shell.

In a particular embodiment, the annular shoulders of the shell comprise evenly spaced protuberances each comprising an angle so as to form gutters configured to cooperate with the fastening means of the annular portions of the first and second supports, said fastening means comprising an alternation of recesses and tabs in the annular portions so that the supports are configured to be fastened to the shell by inserting the protuberances into the recesses and then rotating the tabs in the gutters.

Advantageously, the device comprises an attachment comprising a radial portion configured to be fastened against the radial planar portion of the first support and/or of the second support and a stop configured to be positioned between two protuberances so as to block the rotation of the first and/or second support relative to the shell.

Advantageously, the bearing comprises sintered graphite.

Another object of the present invention is a piping comprising a pipe and a guide device as defined before.

Another object of the present invention is a method for installing and/or assembling a guide device as defined before and/or a piping as defined before, characterised in that it comprises the following steps:
Encircling a pipe of said piping with the bearing;
Placing the insert radially around the bearing;
Placing the elastic means radially around the insert; and
Positioning the shell around the bearing, the elastic means and the insert.

### BRIEF DESCRIPTION OF THE DRAWINGS

Other aims, features and advantages of the invention will become apparent upon reading the following description, given merely as a non-limiting example, and made with reference to the appended drawings, wherein:

FIG. 1 is a schematic assembled view of a device for guiding a piping according to the invention;

FIG. 2 is a schematic view of the different steps of the method for installing and/or assembling a device for guiding a piping according to the invention;

FIG. 3 and

FIG. 4 are schematic views of the guide device of FIG. 1 during a step of assembling an insert;

FIG. 5 is a schematic view of the guide device of FIG. 1 during a step of assembling an elastic means;

FIG. 6 is a schematic view of the guide device of FIG. 1 during a step of assembling a shell;

FIG. 7 is a schematic view of the guide device of FIG. 1 during a step of assembling supports; and

FIG. 8 is a schematic view of the guide device of FIG. 1 during a step of assembling an attachment.

### DETAILED DISCLOSURE OF AT LEAST ONE EMBODIMENT

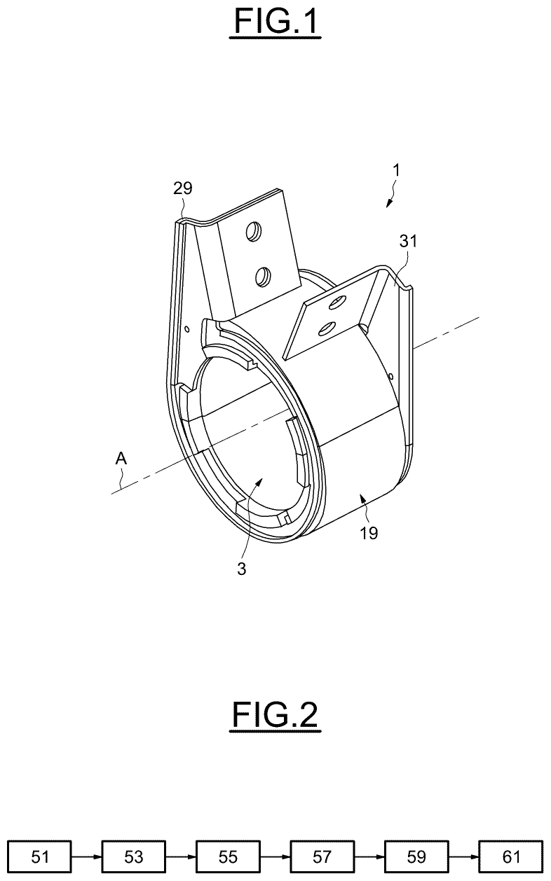

FIG. 1 schematically shows an embodiment of a device 1 for guiding a piping according to the invention. FIG. 1 illustrates an embodiment in which the guide device 1 is assembled.

Moreover, FIG. 2 schematically shows the steps of an implementation of the method for installing and/or assembling the guide device 1 of FIG. 1.

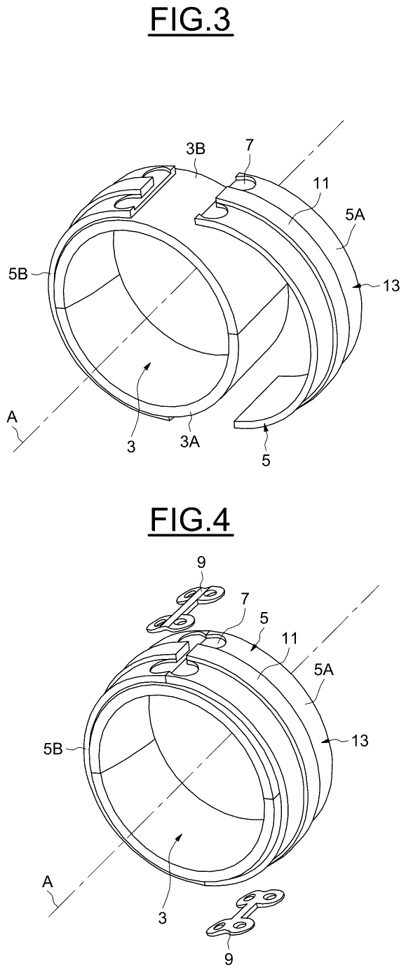

Schematic graphics of the different steps of said method are shown in the following FIGS. 3 to 8.

The guide device 1 comprises a bearing 3 made of a material with a low coefficient of friction. The bearing 3 is configured to encircle a pipe (not shown) of the piping. When the pipe is tubular, the bearing 3 is therefore annular and permanently in contact with said pipe. It serves as a wear part. In particular, the bearing 3 forms a body, for example a powder, between the bearing 3 and the pipe during a run-in period after installation of the bearing 3 around the pipe, the body thus forming a solid lubricant and ensuring lubrication between the bearing 3 and the pipe.

In particular, the bearing 3 comprises a material with a low coefficient of friction such as sintered graphite. Graphite is particularly suitable because it has a low coefficient of friction, has good damping properties and can wear more easily than the material used for manufacturing the pipes of the piping, it thus serves as a wear part.

Hence, the bearing 3 allows conferring on the pipe a longitudinal degree of freedom according to the longitudinal axis A of the bearing 3 and of the piping, and a radial degree of freedom conferred by the material of the bearing 3.

In a particular embodiment, the bearing 3 is made of two elements 3A and 3B, for example two half-ring type elements. Thus, the assembly and disassembly of a bearing 3, and more generally of the guide device 1, is facilitated and could be carried out without disassembling the rest of the piping. This feature is particularly useful for maintenance efficiency and allows, in the case of wear of the guide device 1, replacing only the worn bearing 3 with a new bearing 3. Thus, it is not necessary to replace the entire piping. The bearing 3 is easy to replace and allows increasing and optimising the repairability of the guide device and, consequently, significantly reducing the number of parts that are discarded and which might be difficult to recycle.

The guide device 1 further comprises an insert 5 positioned radially around the bearing 3. The insert 5 is similar to a ring and is visible in FIG. 3.

For example, the insert 5 comprises two elements 5A and 5B, for example two half-ring type elements. Thus, as stated before, the assembly and disassembly of the insert 5, and more generally of the guide device 1, is facilitated and could be carried out without disassembling the rest of the piping.

Optionally, the insert 5 is made of a metal material and comprises at least grooves 7 configured to accommodate metal staples 9. For example, the grooves 7 are formed at the ends of the two elements 5A and 5B. In this embodiment, the insert 5 comprises metal staples 9 shown in FIG. 4 and accommodated in the grooves 7 so as to connect the two elements 5A and 5B together. For example, a staple 9 connects the grooves 7 of two elements 5A and 5B. For example, the staples 9 are welded to the elements of the insert 5 by plug welding.

The insert 5 also comprises a central annular rail 11 on its outer surface 13 allowing stiffening and positioning said insert 5.

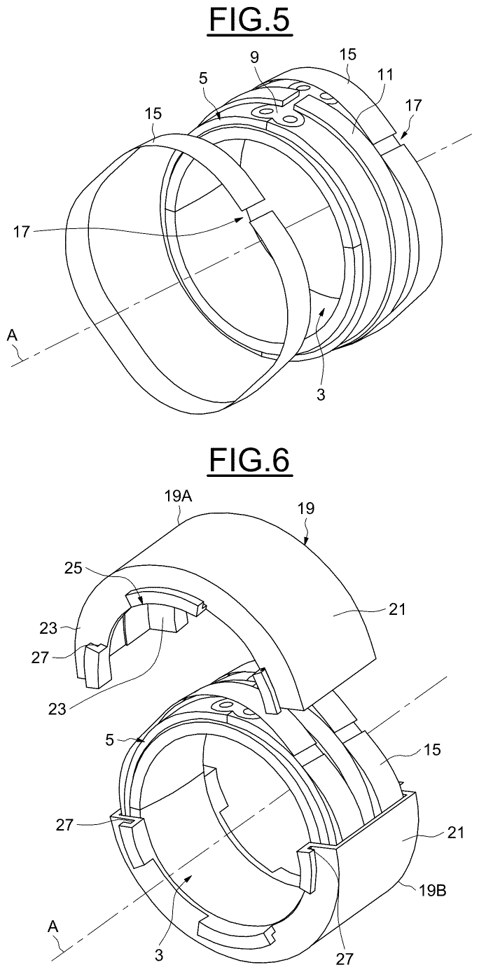

The guide device 1 also comprises an elastic means 15 radially surrounding the insert 5. For example, the elastic means 15 comprises an elastic foam and/or an annular element made of rubber. Preferably, the elastic means comprises a corrugated leaf spring 15 shown in FIGS. 5 and 6.

In the embodiment shown in FIGS. 5 and 6, the guide device 1 comprises two corrugated leaf springs 15 radially surrounding the insert 5. The leaf springs 15 are positioned on either side of the central annular rail 11 of the insert 5, the central annular rail 11 allowing accommodating the leaf springs 15 without these moving according to the longitudinal axis A.

For example, the used leaf spring(s) 15 is/are substantially corrugated, or star-like shaped, so that some portions of the leaf springs 15 are in radial contact with the insert 5 and some portions are not, enabling damping of the radial movements of the pipes of the piping.

Advantageously, the leaf spring(s) 15 comprise(s) an opening 17 allowing inserting them directly onto the insert 5 without completely disassembling the piping.

The guide device 1 also comprises a shell 19 positioned around the bearing 3, the insert 5 and the elastic means 15. For example, the shell 19 is shown in FIG. 6.

For example, the shell 19 is made of a metal material.

The shell 19 comprises a tubular central surface 21 whose inner portion is configured to be at least partially in contact with the elastic means 15. Thus, the elastic means 15, for example the leaf spring, is positioned in a space between the insert 5 and the shell 19 and allows damping some radial movements of a pipe within said space.

The shell 19 further comprises two annular shoulders 23 extending the longitudinal ends of the tubular central surface 21 towards the longitudinal axis A of the guide device 1. However, the dimensions of the annular shoulders 23 are determined so that only the bearing 3 is in contact with a pipe of the piping. In particular, the two annular shoulders 23 are configured to hold the bearing 3, the insert 5 and the elastic means 15 longitudinally when the guide device 1 is assembled.

In the embodiment shown in FIG. 6, the shell 19 comprises two elements 19A and 19B so that the disassembly of the guide device 1 could be carried out without complete disassembly of the piping.

In addition, the annular shoulders 23 of the shell 19 comprise evenly spaced protuberances 25, for example four protuberances 25 distributed over the perimeter formed by an annular shoulder 23, each protuberance 25 comprising an angle so as to form a gutter 27 open towards the radial end of the shell 19.

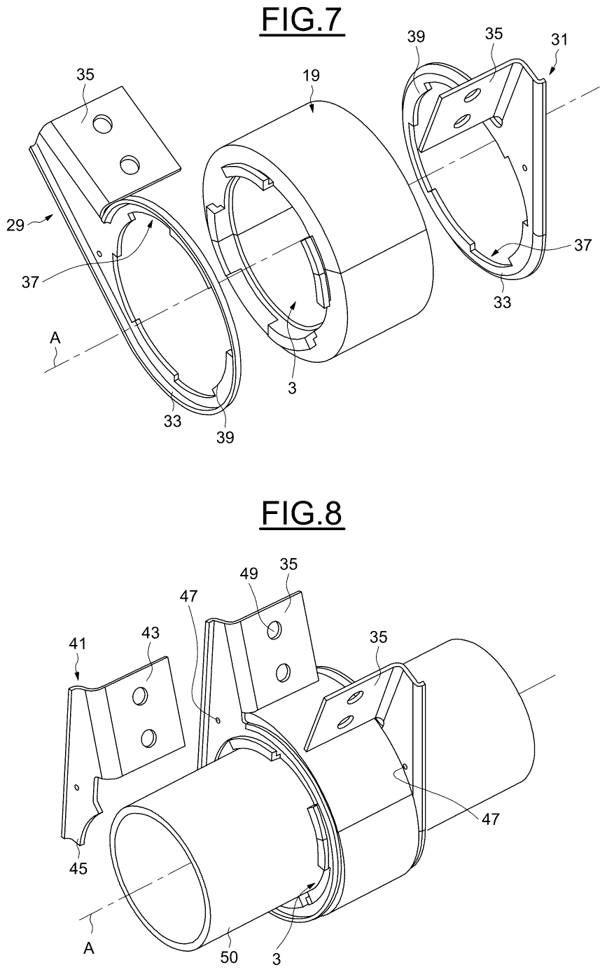

The guide device 1 may also comprise a first support 29 and a second support 31 shown in FIG. 7. Each of the first support 29 and the second support 31 comprises an annular portion 33 and a radial planar portion 35 configured to be positioned radially on the side external to the tubular central surface 21. The annular portions 33 further comprise means 37 and 39 for fastening to the shell 19, the fastening means being reversible.

The fastening means comprise an alternation of recesses 37 and tabs 39 positioned radially inside the annular portions 33.

The first and second supports 29 and 31 are fastened to the shell 19 by inserting the protuberances 25 of the shell 19 into the recesses 37 of the supports 29 and 31, then by rotating the tabs 39 of the supports in the gutters 27 of the shell 19.

Thus, the supports 29 and 31 allow fastening the guide device 1 to an external element and also guaranteeing that the two elements 19A and 19B of the shell 19 are held assembled.

Optionally, the guide device 1 comprises an attachment 41 shown in FIG. 8. The attachment 41 comprises a radial portion 43 configured to be fastened against the radial planar portion 35 of the first support 29 and/or of the second support 31. The attachment 41 also comprises a stop 45 configured to be positioned between two protuberances 25 so as to block the rotation of the support or supports on which the attachment 41 is fixed with respect to the shell 19. Thus, the attachment 41 allows guaranteeing that the first and/or second support 29 and 31 cannot be detached.

In order to facilitate assembly of the attachment 41, each of the attachment 41 and the first and/or second support 29 and 31 comprises an aperture 47 in order to make a brake wire pass therein.

The radial planar portions 35 and the radial portion 43 also comprise at least one orifice 49 intended to accommodate a fastening element (not shown) enabling fastening of the attachment 41 to the supports and/or enabling fastening of the supports 29 and 31 to an external element.

In different variants of the illustrated embodiment, the two supports 29 and 31 are fastened on either side of the same attachment 41, or the first support 29 is fastened to an attachment 41, whereas the second support 31 is fastened to a second attachment. FIG. 1 shows the assembled guide device 1 and wherein the second support 31 is still left free, and may be fastened to the attachment 41 with the first support 29 or may be fastened to a second attachment.

As mentioned before, FIG. 2 schematically shows the steps of an embodiment of the method for installing and/or assembling the guide device 1 of FIG. 1

For the assembly of the guide device 1 and installation thereof around a pipe 50 (shown in FIG. 8) of a piping, a step 51 of encircling said pipe with the bearing 3 is performed at first. More specifically, the two elements 3A and 3B of the bearing 3 are positioned around the pipe so as to form a ring.

Then, a step 53 of placing the insert 5 radially around the bearing 3 is performed. This step 53 is illustrated in particular by FIGS. 3 and 4.

Afterwards, a step 55 of placing the elastic means 15 radially around the insert 5 is performed. This step 55 is illustrated by FIG. 5.

In order to hold these different elements, the shell 19 is positioned in a step 57 around the bearing 3, the insert 5 and the elastic means 15. This step 57 is illustrated by FIG. 6.

In the case of presence of supports 29 and 31, they are placed during a step 59. This step 59 is illustrated by FIG. 7 and comprises inserting the protuberances 25 of the shell 19 into the recesses 37 of the supports 29, then rotating the tongues 39 of the supports in the gutters 27 of the shell 19.

Finally, a step 61 of fastening at least one attachment 41 to at least one support 29 and/or 31. This step 61 is illustrated by FIG. 8.

The present invention is particularly applicable in the context of pipings subjected to high vibrations, such as in aircrafts, for example in aircraft engines, or in ships or submarines.

1. A device for guiding a piping, the device comprising a bearing made of a material with a low coefficient of friction and configured to encircle a pipe of the piping, an insert radially encapsulating the bearing, at least one elastic means radially surrounding the insert, and a shell positioned around the bearing, the elastic means and the insert, each of the bearing, the insert and the shell comprising at least two elements so that disassembling the guide device could be carried out without disassembling the piping.

2. The device according to claim 1, wherein the insert is made of a metal material and comprises grooves configured to accommodate metal staples configured to connect the two elements (5A; 5B) of the insert.

3. The device according to claim 1, wherein the shell is made of a metal material and comprises a tubular central surface configured to be at least partially in contact with the elastic means, and two annular shoulders extending the longitudinal ends of the tubular central surface towards the longitudinal axis of the guide device and of the piping, the two annular shoulders being configured to longitudinally hold the bearing, the elastic means and the insert.

4. The device according to claim 1, comprising a first support and a second support each comprising an annular portion and a radial planar portion configured to be positioned radially on the shell, the annular portions of the first and second supports comprising means for reversible fastening to the shell.

5. The device according to claim 4, wherein the annular shoulders of the shell comprise evenly spaced protuberances each comprising an angle so as to form gutters configured to cooperate with the fastening means of the annular portions of the first and second supports, said fastening means comprising an alternation of recesses and tabs in the annular portions so that the supports are configured to be fastened to the shell by inserting the protuberances into the recesses and then rotating the tabs in the gutters.

6. The device according to claim 5, comprising an attachment comprising a radial portion configured to be fastened against the radial planar portion of the first support and/or of the second support and a stop configured to be positioned between two protuberances so as to block the rotation of the first and/or second support relative to the shell.

7. The device according to claim 1, wherein the bearing comprises sintered graphite.

8. A piping comprising a pipe and a guide device according to claim 1.

9. A method for installing and/or assembling a guide device according to claim 1, and/or a piping according to claim 8, the method comprising the following steps:
Encircling a pipe of said piping with the bearing;
Placing the insert radially around the bearing (step 53);
Placing the elastic means radially around the insert (step 55); and
Positioning the shell around the bearing, the elastic means and the insert (step 57).
